(19) United States
(12) Patent Application Publication
(10) Pub. No.: US 2012/0055748 A1
(43) Pub. Date: Mar. 8, 2012

(54) Damper device

(75) Inventors: Yusuke Imai, Sagamihara-shi (JP); Kei Shimozaki, Yokohama-shi (JP); Yoshitsugu Homma, Utsunomiya-shi (JP)

(73) Assignee: NIFCO INC., Yokohama-shi (JP)

(21) Appl. No.: 13/137,589

(22) Filed: Aug. 29, 2011

(30) Foreign Application Priority Data
Aug. 27, 2010 (JP) 2010-190878

(51) Int. Cl. F16F 9/508

(52) U.S. Cl. 188/280

(57) ABSTRACT

A damper device includes a cylinder body, and a piston body. At least one end of either the cylinder body or the piston body is linked to an object to be braked to brake a relative movement or a movement of the object to be braked. The cylinder body includes a blocking member made of a synthetic resin at a deep inner section opposing to the piston body. The blocking member is formed separately from the cylinder body, and installed in one end of a tubular-shaped body forming the cylinder body. The blocking member has a fluid passage section and a braking force variable member moved therein. The braking force variable member holds passage of a fluid passing through the fluid passage section at a time of a movement of the piston body in a direction leaving from the deep inner section.

### FIELD OF THE INVENTION

The invention relates to an improvement of a damper device which has a cylinder body housing a piston body so that the piston body may provide braking for movement thereof.

### BACKGROUND ART

There is a damper device in which a through-hole making the inside and the outside of a cylinder body communicate with each other is formed in the deep inner section opposed to the piston body in the cylinder body, and a stopper-shaped body provided with a shaft movably inserted into said through-hole is disposed in the outside of a cylinder body. (cf. Patent Document 1) In such damper device, the forward movement of the piston body in the direction leaving from said deep inner section is allowed by means of the inflow of gas from said through-hole and the insertion volume of the shaft of the stopper-shaped body in said through-hole is increased by this inflow of gas. When the insertion volume of such shaft increases, because the gas becomes difficult to pass through said through-hole, braking for said forward movement of the piston body increases. Thereby, as the movement of an object to be braked attached to a piston body increases, the braking force of a damper device applied to said object to be braked increases.

However, in the damper device as shown in the Patent Document 1, because the deep inner section which is formed integrally with the other parts of the cylinder body to block up one end of the cylinder body is provided with said through-hole, if such cylinder body is molded in synthetic resin, the dimensional accuracy of said through-hole becomes hard to be improved.

When such through-hole is not formed according to a predetermined dimension, a gas passage gap between said shaft and such through-hole cannot be formed according to a desired dimension and the damper device does not exert a desired braking force.

Patent Document
Japanese Patent Unexamined Publication No. 2008-275138

### Problem to be Solved by the Invention

The main problem that this invention is going to solve is to improve the dimensional accuracy of a fluid passage section (the through-hole of Patent Document 1) formed in said deep inner section as much as possible while forming at least the deep inner section of the cylinder body forming part of the damper device made of a synthetic resin.

### Means to Solve the Problem

To achieve said object, a damper device in this invention comprises a cylinder body and a piston body, in which at least either the cylinder body or the piston body is adapted to be linked to an object to be braked to brake a relative movement or a movement of the object to be braked. The deep inner section opposing to the piston body in the cylinder body has a blocking member made of a synthetic resin and installed in one end of a tubular-shaped body forming the cylinder body. The blocking member has a fluid passage section and a braking force variable member moved in a direction to hold up the passage of a fluid by the fluid passing through the fluid passage section at the time of the movement of the piston body in a direction leaving from said deep inner section.

When the piston body is moved forward, the fluid flows into the cylinder body through the passage section from the outside, and because the fluid becomes difficult to pass through the passage section when the braking force variable member is moved by this inflow, the resistance for the forward movement or the braking force of the piston body can be increased compared to when merely the passage section is provided. Because the blocking member made of a synthetic resin is attached to one end of the tubular-shaped body forming the cylinder body and forms the deep inner section of the cylinder body, the dimensional accuracy of the passage section can be improved compared to when the deep inner section having the passage section is provided integrally with the tubular-shaped body.

### Effect of the Invention

According to the damper device of this invention, because the deep inner section of the cylinder body forming the damper device is configured such that a blocking member prepared separately from said tubular-shaped body is attached to one end of said tubular-shaped body, the dimensional accuracy of the fluid passage section which is formed in said deep inner section or blocking member can be improved compared to when said deep inner section is integrally molded with said tubular-shaped body. As a result, the damper device is certainly able to exert a desired braking force.

### BRIEF DESCRIPTION OF DRAWINGS

FIG. 1 is a front view of the damper device.

FIG. 2 is a left side view of the damper device.

FIG. 3 is a cross-sectional view thereof taken along the line A-A in FIG. 1, in which the piston body is in a position before the forward movement.

FIG. 4 is an enlarged cross-sectional view of the essential parts of the damper device, in which the piston body is in a position before the forward movement.

FIG. 5 is a cross-sectional view of the damper device showing a condition in which the piston body has just finished moving forward from the state of FIG. 3.

FIG. 6 is a front view of a casing (the left figure) and a stopper member (the right figure) forming the blocking member.

FIG. 7 is a cross-sectional view taken along the line B-B in FIG. 6.

FIG. 8 is a cross-sectional view showing the essential parts of another example of configuration resulting from a partial modification of the configuration shown in FIG. 1 through FIG. 7.

### MODES OF CARRYING OUT THE INVENTION

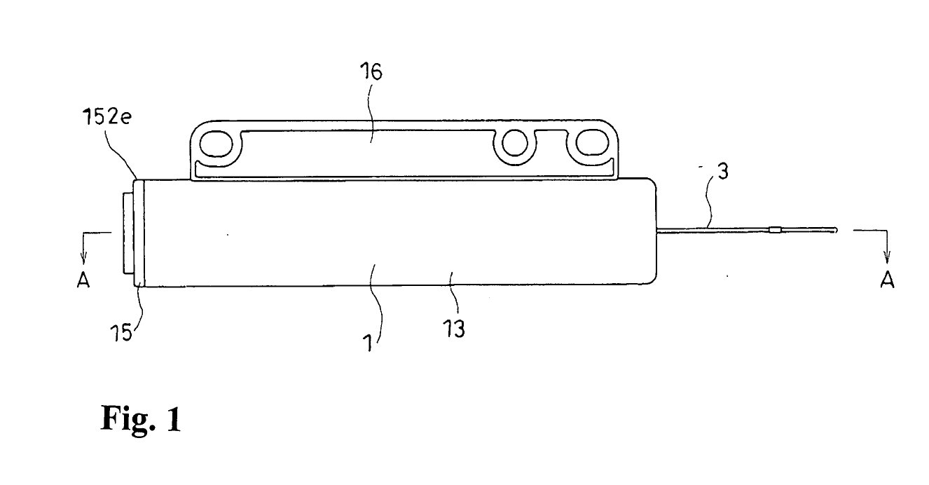

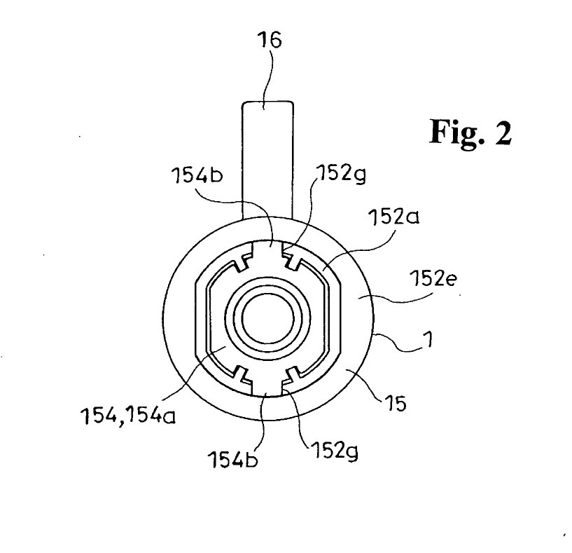

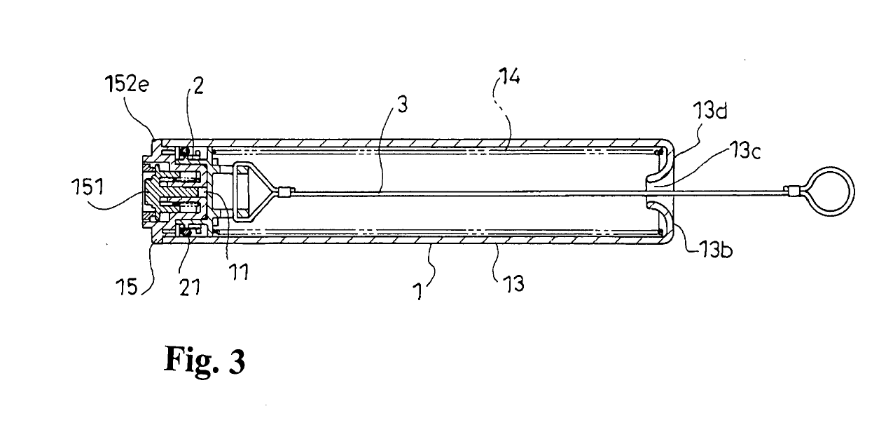

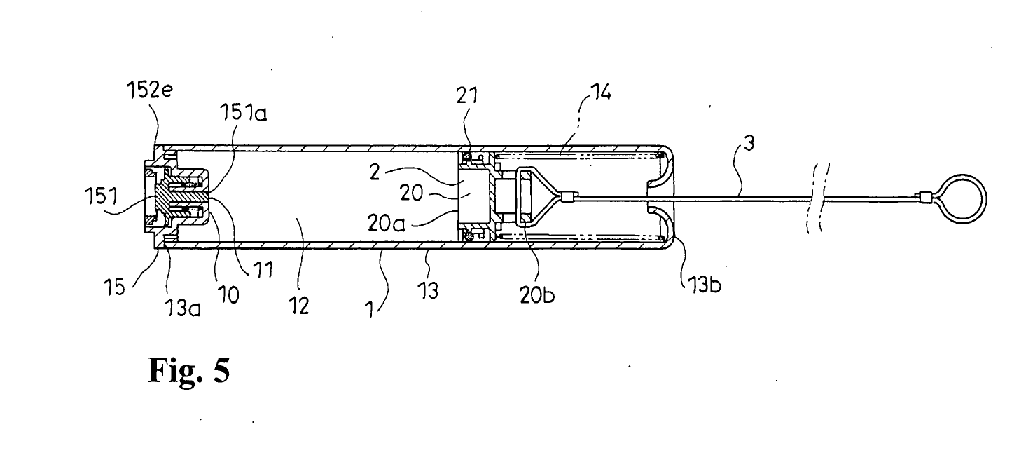

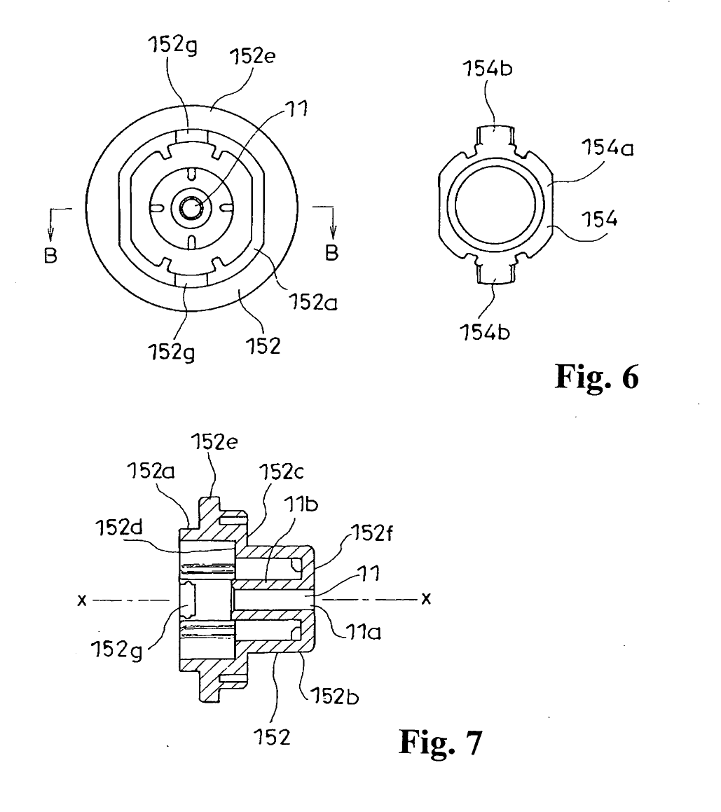

Hereinafter, typical examples for carrying out this invention are explained based on FIG. 1 to FIG. 8. The damper device according to this preferred embodiment of the invention has a cylinder body 1 housing a piston body 2 so that the piston body 2 may provide braking for movement thereof and it is generally called a “piston damper.”

Such damper device is used to provide braking force for movement or relative movement of an object to be braked, typically, a movable body of different types. Such damper device is used to provide a braking force for movement of a movable body such as one which is rotated like a door and a lid or one which is moved slidably like a drawer. Also, such damper device, typically, effects a braking force for movement of such movable body by connecting either a cylinder body 1 or a piston body 2 to either a stationary body in support of said movable body or such movable body and by connecting the other of the cylinder body 1 or the piston body 2 to the other of said stationary body or the movable body. Such connection includes not only a case where the cylinder body 1 or piston body 2 is directly attached to a stationary body or a movable body but also a case where the cylinder body 1 or piston body 2 is indirectly attached thereto through a transmission member 3. In the depicted example, with one end of a cord fixed to the piston body 2 and a cord-shaped body resulting from the other end side of the cord drawn out from the other end of a tubular-shaped body 13 which forms the cylinder body 1 as the transmission member 3, the piston body 2 is enabled to be connected to a movable body which is an object to be braked, not illustrated in the depicted example.

In the depicted example, when the piston body 2 in a most pushed state by the cylinder body 1 follows the movement of the movable body through said transmission member 3 and moves in the direction leaving from deep an inner section 10 of the cylinder body 1 (Hereinafter, the movement of the piston body 2 in this direction is referred to as forward movement), the piston body 2 is configured so as to exert resistance or braking for the forward movement on said movable body.

Specifically, in the depicted example, the forward movement of the piston body 2 is allowed by the inflow of a fluid (“air” in the depicted example) in the cylinder body 1 through a fluid passage section 11 formed in the deep inner section 10, and by making the passage section 11 orifice-shaped, the pressure of a pressure chamber 12 between the deep inner section 10 of the cylinder 1 and the piston body 2 becomes lower than that of the outside at the time of said movement. A resistance is thereby provided for the forward movement of the piston body 2.

Also, in the depicted example, a compression coil spring 14 is housed between such piston body 2 and the other end of a tubular-shaped body 13 forming the cylinder body 1 and piston body 2 is urged constantly in the direction approaching said deep inner section 10. Such compression coil spring 14 is also thereby adapted to exert resistance for forward movement of the piston body 2 and when said movable body moves in the opposite direction after stopping the forward movement, the piston body 2 is adapted to be reciprocated by means of the action of such compression coil spring 14.

In the depicted example, the piston body 2 has a tubular-shaped main portion 20 which opens a tube forward end 20a opposed to the deep inner section 10 of the cylinder body 1 and blocks the tube rear end opposite thereto. There is fitted a seal ring 21 in the outside of said main portion 20. In the depicted example, the seal ring 21 moves to the tube forward end 20a side of a main portion 20 at the time of the forward movement of the piston body 2 and seals inside surfaces between the piston body 2 and the tubular-shaped body 13 forming the cylinder body 1, while at the time of the reciprocation of the piston body 2, the seal ring 21 moves to the tube rear end side of the main portion 20 and a backward outflow of air by the piston body 2 is then allowed. In the tube rear end of the main portion 20 of piston body 2, there is disposed a fixing section 20b on the side of one end of a cord of the cord-shaped body which becomes the transmission member 3.

The cylinder body 1 is made of the tubular-shaped body 13 and the blocking member 15 made of a synthetic resin. The tubular-shaped body 13 is cylindrical in shape, and the blocking member 15 is installed to block in free one end thereof. Numeral 16 in the figure shows a bracket section for attaching said tubular-shaped body 13 or cylinder body 1 to said stationary body. There is formed a funnel tube-shaped section 13c in the other end of the tubular-shaped body 13.

The funnel tube-shaped section 13c has the tube end at the side of expanded diameter which extends integrally to the other end of the tubular-shaped body 13 through a circular radius section 13d, and the tube end at the side of a reduced diameter located within the tubular-shaped body 13.

The cord-shaped body having the side of one end of a cord thereof fixed to the piston body 2 is drawn out from the other end of the tubular-shaped body 13 outwardly through said funnel tube-shaped section 13c, and if it is not drawn straight, it is guided through the circular radius section 13d.

In this preferred embodiment of the invention, because the deep inner section 10 of the cylinder body 1 is comprised of said blocking member 15, an advantage is provided in that said funnel tube-shaped section 13c and cylinder body 1 comprising circular radius section 13d can be molded integrally by a synthetic resin.

The spring 14 is housed in cylinder body 1 such that one end of the spring abuts against the tube rear end of the main portion 20 of the piston body 2 and the other end of the spring abuts against the inside surface of said circular radius section 13d.

The deep inner section 10 opposed to the piston body 2 in the cylinder body 1, which has the blocking member 15 made of a synthetic resin installed in one end of said tubular-shaped body 13. Also, this blocking member 15 is provided with said fluid passage section 11 and braking force variable member 151 moved in the direction holding the passage by a fluid passing through said fluid passage section 11 at the time of movement of said deep inner section 10 in the direction leaving from the piston body 2. The braking force variable member 151 has an insertion shaft 151a to said fluid passage section 11.

And said braking force variable member 151 is moved to increase insertion volume of the insertion shaft 151a into the fluid passage section 11 by a fluid passing through the fluid passage section 11 at the time of the movement of the piston body 2 in the direction leaving from the deep inner section 10 of the cylinder body 1.

In the depicted example, the blocking member has a shape such that a part thereof enters into said cylinder body 1 through one end of said cylinder body 1 to block said one end.

The blocking member 15 is provided with a tubular-shaped casing 152 which has a large-diameter section 152a having outside diameter thereof made approximately equal to an inside diameter of the tubular-shaped body 13 of the cylinder body 1 and a small-diameter section 152b having an outside diameter made approximately equal to an inside diameter of the main portion 20 of the piston body 2. The outer circular bump surface 152c and inner circular bump surface 152d are formed between the large-diameter section 152a and small-diameter section 152b of this casing 152. Also, a circular flange section 152e is formed in the periphery of the large-diameter section 152a. The outside diameter of the circular flange section 152e is approximately equal to the outside diameter of the tubular-shaped body 13. The tube edge of the large-diameter section 152a side of the casing 152 is left open. The tube end of the small-diameter section 152b side of the casing 152 is blocked up by the base plate 152f where a small opening 11a forming part of said passage section 11 is formed in the center thereof. There is disposed within the casing 152 a small tube section lib which sticks out from a base plate 152f along the central axis x of said casing 152 and reaches slightly forward of the inside circular bump surface 152d. The stuck out end of the small tube section 11b is left open while the base end thereof is communicated with said small opening 11a, and a fluid passage section 11, which has said small tube section 11b and small opening 11a. (FIG. 7)

The braking force variable member 151 is provided with a disc-shaped head 151b and said insertion shaft 151a sticking out from the center of one side of said head 151b. The insertion shaft 151a is configured so as to have an outside diameter slightly smaller than the inside diameter of said passage section 11, or that of the inside diameter of said small tube section 11b and small opening 11a. Further, in one side of the head 151b, a circular side wall 151c is formed as if to surround the insertion shaft 151a. The outside diameter of the circular side wall 151c is configured to be a little smaller than the inside diameter of small-diameter section 152b of casing 152.

Having its insertion shaft 151a inserted into said small tube section 11b forming the passage section 11 and having the circular side wall 151c get inside of said small-diameter section 152b, the braking force variable member 151 is movably housed within the casing 152 along the central axis x of said casing 152.

Between the head 151b of the braking force variable member 151 housed in this way and the base plate 152f of the casing 152, a compression coil spring 153 is placed passing said small tube section 11b through its inside.

Further, in the tube end of the large-diameter section 152a side of the casing 152, there is mounted a stopper member 154 abutted on another side of the head 151b of the braking force variable member 15 by the urging action of said spring 153. A stopper member 154 has a circular portion 154a and an ear 154b sticking out outwardly from said circular portion 154a in both sides in the diametrical direction of said circular portion 154a.

In both sides in the diametrical direction of the large-diameter section 152a of the casing 152, there is formed a cut out opening section 152g in which a part of said large diameter 152a is cut out as far as said circular flange section 152e is not reached.

In the depicted example, the stopper member 154 is mounted on the casing 152 by having the corresponding ear 154b of the stopper member 154 fitted in the cut out opening section 152g formed in the large-diameter section 152a of said casing 152, from a state where the braking force variable member 151 is housed within casing 152 as described before.

In the example shown in FIG. 1-FIG. 7, the blocking member 15 is mounted to the tubular-shaped body 13 by welding. Specifically, the blocking member 15 is mounted on the tubular-shaped body 13 by having said circular flange section 152e welded to one end of the tubular-shaped body 13 from a state where the side of small-diameter section 152b in front of the circular flange section 152e of the casing 152 forming the blocking member 15 has been inserted within the tubular-shaped body 13. By such welding, the tubular-shaped body 13 and blocking member 15 can be mounted strongly, and the sealing of the joint portion of both can be improved. Such welding can be done using a wide variety of well-known methods to weld synthetic resin such as the supersonic wave welding. In this preferred embodiment of the invention, because the fluid passage section 11 is disposed in the center of the blocking member 15, a special feature is provided there in that passage section 11 is hard to undergo the effect of such welding.

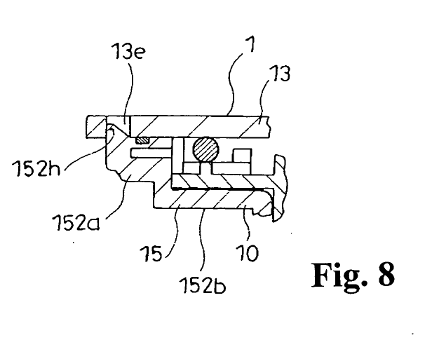

As shown in FIG. 8, the blocking member 15 can be mounted on the tubular-shaped body 13 by having the engagement section 152h disposed in either one of these engage with an engaged section 13e disposed in the other of these. In this particular example, a claw engagement section 152h is formed in the outside of the large-diameter section 152a of the casing 152 forming the blocking member 15.

At the time of fitting of the blocking member 15 into the tubular-shaped body 13 of the cylinder body 1, by elastically deforming the side of said tubular-shaped body 13, the fitting-in of the blocking member 15 is allowed up to a position where this engagement section 152h gets into an orifice-shaped to-be-engaged section 13e disposed in one end of said tubular-shaped body 13 and by the elastic reset in this position, the engagement section 152h is inserted into the engaged section 13e and is engaged therewith. By such engagement, the tubular-shaped body 13 and blocking member 15 can be attached easily.

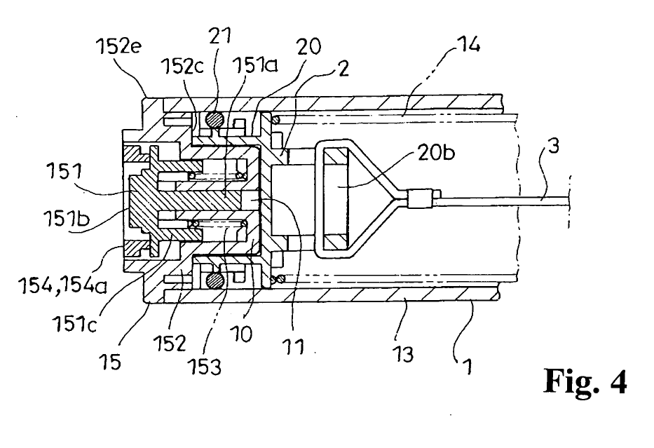

In a state where piston body 2 is most pushed into the cylinder body 1, the insertion shaft 151a of the braking force variable member 151 is adapted not to be inserted completely into the passage section 11 by the urging action of said spring 153. (FIG. 4) In the depicted example, the tube forward end of the main portion 20 of the piston body 2 now abuts against the outside circular bump surface 152c of the casing 152 of the blocking member 15, and the small-diameter section 152b of the casing 152 is adapted to fit in this main portion 20.

When the piston body 2 is moved forward from such state, gas flows into the cylinder body 1 from the outside through passage section 11 and by this inflow, the braking force variable member 151 is moved toward the inside of cylinder body 1 resisting the urging action of said spring, and insertion volume of the insertion shaft 151a into said passage section 11 is increased. When the braking force variable member 151 is moved in this way, because passing gas through the passage section 11 becomes difficult, the resistance for the forward movement or the braking force of piston body 2 can be increased compared to when passage section 11 is merely provided. As the insertion volume of the insertion shaft 151a into the passage section 11 increases, it becomes more difficult for gas to pass through the passage section 11 and the pressure differential between said pressure chamber 12 and the outside increases.

Thereby, as the movement speed of said movable body or the forward movement speed of the piston body 2 increases, the insertion volume of the insertion shaft 151a into the passage section 11 increases and the pressure differential between said pressure chamber 12 and the outside increases. The resistance for said piston body 2 or the braking force for a movable body can thus be increased. That is to say, the damper device according to this preferred embodiment of the invention becomes a so-called “speed responsive type piston damper.”

Because the blocking member 15 made of a synthetic resin forms part of the deep inner section 10 of the cylinder body 1, and is attached to one end of the tubular-shaped body 13 forming the cylinder body 1, the dimensional accuracy of the passage section 11 can be improved compared to when the deep inner section 10 comprising the passage section 11 is integrally molded with the tubular-shaped body 13. As a result, the damper device is certainly able to exert a desired braking force.

The disclosure of Japanese Patent Application No. 2010-190878 filed on Aug. 27, 2010 is incorporated herein as a reference.

While the invention has been explained with reference to the specific embodiments of the invention, the explanation is illustrative, and the invention is limited only by the appended claims.

What is claimed is:

1. A damper device comprising:
a cylinder body, and
a piston body, in which at least one end of either the cylinder body or the piston body is adapted to be linked to an object to be braked to brake a relative movement or a movement of the object to be braked,
wherein the cylinder body includes a blocking member made of a synthetic resin at a deep inner section opposing the piston body, the blocking member being formed separately from the cylinder body and installed in one end of a tubular-shaped body forming the cylinder body, and
wherein the blocking member has a fluid passage section and a braking force variable member moved in the fluid passage section, the braking force variable member holding passage of a fluid passing through the fluid passage section at a time of a movement of the piston body in a direction leaving from the deep inner section.

2. A damper device according to claim 1, wherein the braking force variable member comprises an insertion shaft to the fluid passage section, and is arranged such that at a time of the movement of the piston body in the direction leaving from the deep inner section of the cylinder body, the braking force variable member is moved to increase an insertion volume of the insertion shaft into the fluid passage section by the fluid passing through the fluid passage section.

3. A damper device according to claim 1, wherein the blocking member is mounted on the tubular-shaped body by welding.

4. A damper device according to claim 1, wherein the blocking member includes an engagement section disposed in either one of the blocking member or the tubular-shaped body, and an engaged section disposed in the other of the blocking member or the tubular-shaped body engaging the engagement section so that the blocking member is mounted on the tubular-shaped body.

5. A damper device according to claim 1, wherein the blocking member includes the fluid passage section at a center thereof.

6. A damper device according to claim 1, further comprising a cord-shaped body having one end fixed to the piston body and the other end drawn out from the other end of the tubular-shaped body forming the cylinder body.
